(19) United States
(12) Patent Application Publication
(10) Pub. No.: US 2007/0230392 A1
(43) Pub. Date: Oct. 4, 2007

(54) Minimization of in-band noise in a WLAN network

(76) Inventors: Stewart Lane Adams, (US); Daryl Cromer, Cary, NC (US); Philip John Jakes, Durham, NC (US); Howard Jeffrey Locker, Cary, NC (US); Raymond Gary Octaviano II, Raleigh, NC (US)

Correspondence Address: DILLION & YUDELL LLP, 8911 N. CAPITAL OF TEXAS HWY, SUITE 2110, AUSTIN, TX, 78759, US

(21) Appl. No.: 11/395,780

(22) Filed: Mar. 31, 2006

(51) Int. Cl. H04Q 7/24; H04B 7/185

(52) U.S. Cl. 370/318; 370/338; 455/63.1

(57) ABSTRACT

A method, apparatus and computer-usable medium for minimizing in-band noise in a WLAN network is presented. The method includes the steps of detecting, at a first wireless client device that communicates with a Wireless Local Area Network (WLAN) via a first access point, a signal interference that is caused by a second wireless client device that communicates with the WLAN via a second access point; and minimizing the signal interference by sending an instruction to the second wireless access device to reduce a transmission power level of the second wireless device.

### BACKGROUND OF THE INVENTION

1. Technical Field

The present invention relates in general to the field of computers and similar technologies, and in particular to wireless networks. Still more particularly, the present invention relates to minimizing in-band noise to a first client computer in a first cell caused by a second client computer in a second cell.

2. Description of the Related Art

As wireless devices become more popular and prevalent, more locations are providing wireless “hot spots.” These hot spots may be found in retail establishments such as coffee shops and restaurants, enterprise settings such as universities and corporate campuses, residential areas such as apartment complexes, hotels, etc. Each hot spot is essentially a small cell that provides access to a Wireless Local Area Network (WLAN) via an access point (such as a wireless router). The WLAN ultimately provides access to larger networks such as the Internet. While such hot spots are useful and convenient, because of their ubiquitous nature, there is often in-band noise caused by the close proximity of the cells. To minimize coverage areas and to increase density in a given area, network administrators often will reduce the power output of the access points (i.e., from 70 mW to 10 mW).

Consider now WLAN 100 depicted in FIG. 1. WLAN 100 is a Wi-Fi system that is in compliance with the IEEE 802.11x specifications, which are incorporated herein by reference in their entirety. WLAN 100 is depicted for exemplary purposes as having four Wi-Fi cells 102-1,2,3,4. Wi-Fi cells 102-1,2,3,4 each have a respective Access Point (AP) 1,2,3,4. Note that while AP 3 and AP 4 are running on different channels (11 and 6 respectively), AP 1 and AP 2 are both on Channel 1. Note also that a first wireless device denoted as “Client A” communicates with AP 1, while a second client device denoted as “Client B” communicates with AP 2.

Note also that Client A and Client B are in close physical proximity to each other. This becomes problematic if AP 2 reduces its transmission power for reasons described above, or if AP 2 is configured to lower transmission power to set cell size. When Client B detects the weakened signal from AP 2, Client B “assumes” that AP 2 is far away (or is subject to signal restriction from an intermediary source such as a Radio Frequency (RF) barrier). To compensate for AP 2's distance, Client B pushes its transmitter up to full power. However, this “solution” causes Client B to generate a broad area of transmitted signal, shown in FIG. 2 as area 200. Note that area 200 extends into cell 102-1, thus causing an in-band signal interference (noise) to Client A. Thus, there is a need for a solution to such signal interference.

### SUMMARY OF THE INVENTION

To address the need described above for an improved method and system for minimizing in-band noise in a WLAN network, the present invention includes, but is not limited to, a method, apparatus and computer-usable medium for detecting, at a first wireless client device that communicates with a Wireless Local Area Network (WLAN) via a first access point, a signal interference that is caused by a second wireless client device that communicates with the WLAN via a second access point; and minimizing the signal interference by sending an instruction to the second wireless access device to reduce a transmission power level of the second wireless device.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates a prior art Wireless Local Area Network (WLAN) having multiple Wi-Fi cells;

FIG. 2 depicts a coverage area of signal interference caused by a computer in one of the Wi-Fi cells in the WLAN illustrated in FIG. 1;

FIG. 3 illustrates a flow-chart of exemplary steps taken to minimize signal interference caused by the computer described in FIG. 2; and

FIG. 4 depicts an exemplary client computer in which the present invention may be implemented.

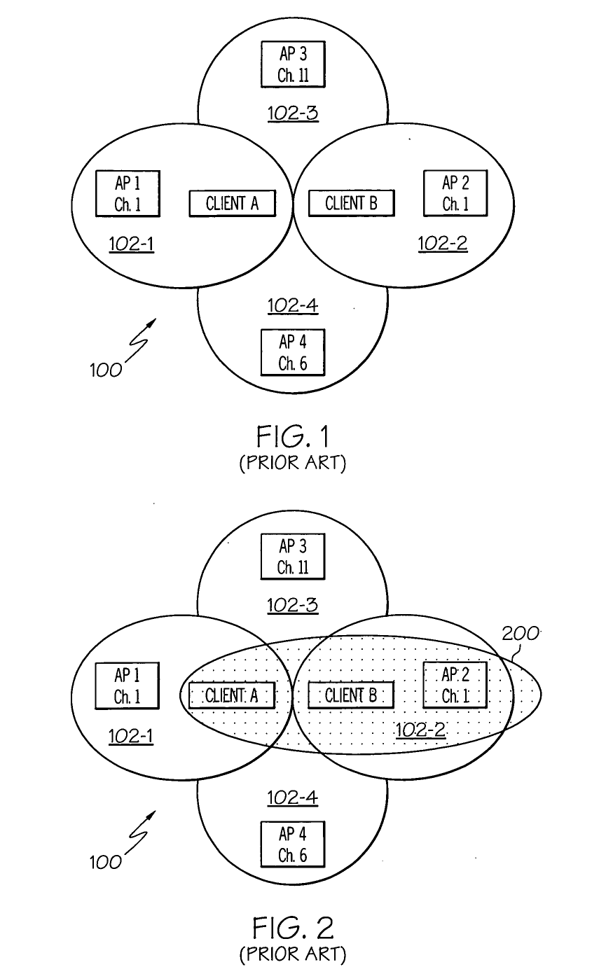

### DETAILED DESCRIPTION OF THE PREFERRED EMBODIMENT

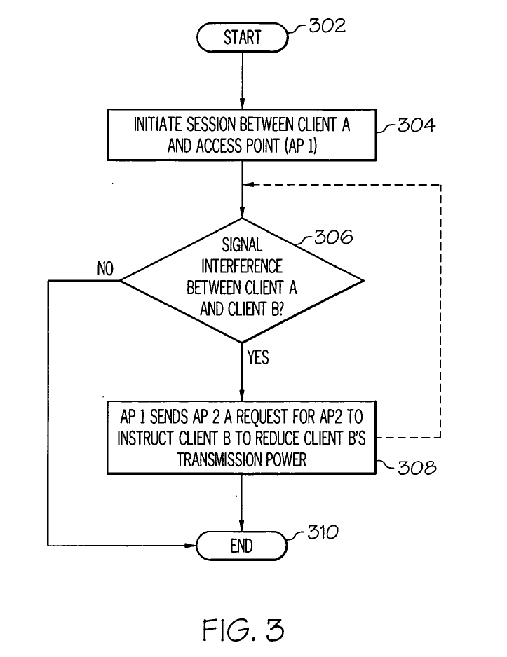

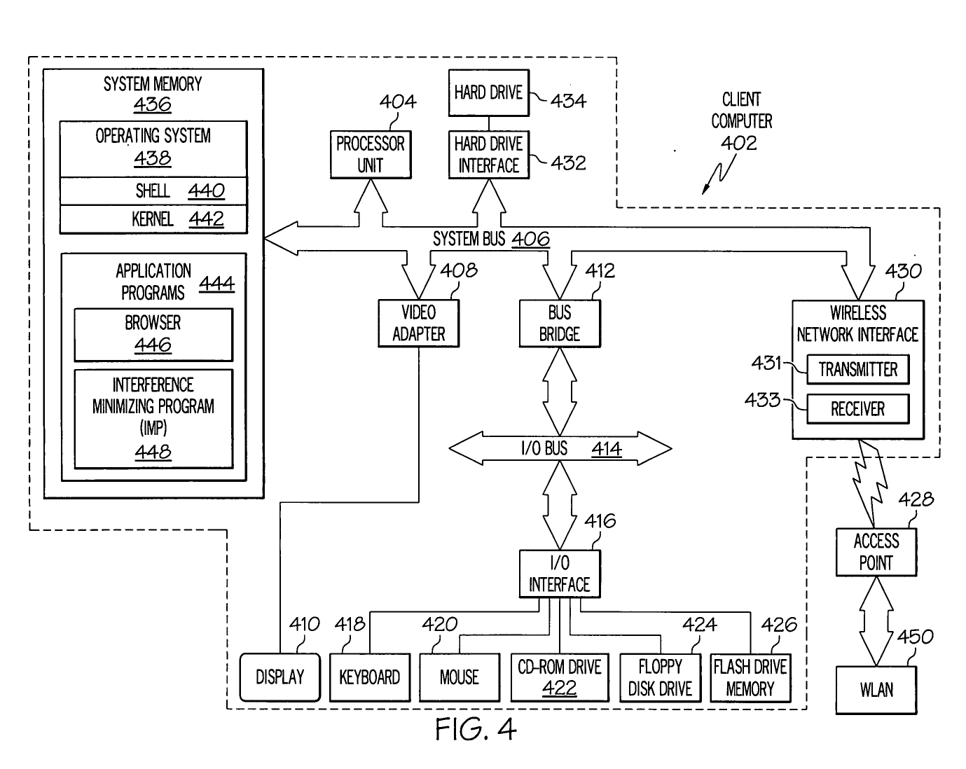

With reference now to FIG. 3, a flow-chart of exemplary steps taken in the present invention is presented. After initiator block 302, a first wireless client device (e.g., Client A shown in FIG. 1) establishes a communication session with a first access point (e.g., AP 1 shown in FIG. 1) to communicate with a Wireless Local Area Network (WLAN), as described in block 304. The first wireless client device (Client A) scans for and detects a signal interference (i.e., an in-band noise) from a second wireless device (Client B) (query block 306). Note that the second wireless device (Client B) communicates with a second access point (AP 2) in the WLAN (i.e., the first and second access points are different). The first wireless device (Client A) (or alternatively, the first access point AP 1) is able to determine which access point is servicing the second wireless device (Client B) that is causing the in-band noise (by transmitting at too high a power, presumably in an attempt to compensate for a reduced power level of a signal being received from the second access point AP 2). This determination is made by the first wireless device Client A (or else the first access point AP 1) reading a Media Access Control (MAC) address in a header of a data packet that was sent by the second wireless device Client B. Note that this determination may be made by logic within the first wireless device Client A, such as a processor unit 404 shown for (wireless) client device 402 depicted in FIG. 4.

After determining which access point (AP 2) is communicating with the offensive wireless device (the second wireless device Client B), the first wireless device Client A sends a message to the first access point AP 1, requesting that the first access point AP 1 contact the second access point AP 2 with an instruction for the second wireless device (Client B) to turn down the transmission power in the second wireless device's transmitter (block 308). By turning down the power in the transmitter in the wireless card in the second wireless device (e.g., transmitter 431 described below and used by the second wireless device), then the in-band noise (signal interference) to the first wireless device is minimized, preferably to a pre-determined acceptable level, and the process ends (terminator block 310). Note that, as indicated by the dotted line, the first access point can send multiple instructions, in an iterative manner, to the second access point to reduce the transmission power of the second wireless device. That is, the second wireless device turns down its transmitting power in incremental steps until the first wireless device no longer experiences problematic in-band noise caused by the second wireless device. In another embodiment, control of the transmitting power of the second wireless device can be managed by reporting the in-band noise condition experienced by the first wireless device to a central control site, which then automatically rebalances all access points (including the first and second access points) to correct the in-band noise problem.

With reference now to FIG. 4, there is depicted a block diagram of an exemplary wireless device, depicted as client computer 402, in which the present invention may be utilized. Client computer 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk-Read Only Memory (CD-ROM) drive 422, a floppy disk drive 424, and a flash drive memory 426. The format of the ports connected to I/0 interface 416 may be any known to those skilled in the art of computer architecture, including but not limited to Universal Serial Bus (USB) ports.

Client computer 402 is able to wirelessly communicate with a Wireless Local Area Network (WLAN) 450 via an access point 428 using a wireless network interface 430, which is coupled to system bus 406. WLAN 450 (such as WLAN 100 shown in FIG. 1) may be connected to an external network such as the Internet, or an internal network such as an Ethernet or a Virtual Private Network (VPN). Note that wireless network interface 430 includes a transmitter 431 for transmitting data packets to access point 428, and a receiver 433 for receiving data packets from access point 428.

A hard drive interface 432 is also coupled to system bus 406. Hard drive interface 432 interfaces with a hard drive 434. In a preferred embodiment, hard drive 434 populates a system memory 436, which is also coupled to system bus 406. Data that populates system memory 436 includes client computer 402's operating system (OS) 438 and application programs 444.

OS 438 includes a shell 440, for providing transparent user access to resources such as application programs 444. Generally, shell 440 is a program that provides an interpreter and an interface between the user and the operating system. More specifically, shell 440 executes commands that are entered into a command line user interface or from a file. Thus, shell 440 (as it is called in UNIX®, also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., client computer 402) to send and receive network messages to the Internet using HyperText Transfer Protocol (HTTP) messaging, thus enabling communication with the Internet.

Application programs 444 in client computer 402's system memory also include an Interference Minimizing Program (IMP) 448. ET 448 includes code for implementing the processes described above in FIG. 3. Note that the hardware depicted for client computer 402 may be utilized by both a first wireless device and a second wireless device, as contemplated by the presently claimed invention.

The hardware elements depicted in client computer 402 are not intended to be exhaustive, but rather are representative to highlight essential components required by the present invention. For instance, client computer 402 may include alternate memory storage devices such as magnetic cassettes, Digital Versatile Disks (DVDs), Bernoulli cartridges, and the like. These and other variations are intended to be within the spirit and scope of the present invention.

The present invention thus presents a method for minimizing in-band noise from a nearby wireless device. In one embodiment, the method includes the steps of detecting, at a first wireless client device that communicates with a Wireless Local Area Network (WLAN) via a first access point, a signal interference that is caused by a second wireless client device that communicates with the WLAN via a second access point; and minimizing the signal interference by sending an instruction to the second wireless access device to reduce a transmission power level of the second wireless device. The signal interference may be an in-band radio frequency interference. Furthermore, the method may include the step of sending, to the second wireless device, multiple instructions to reduce the transmission power level of the second wireless device until the signal interference is reduced to a pre-determined acceptable level. The instruction to reduce the transmitting power of the second wireless device may be sent from the first access point to the second access point, wherein the first access point identifies the second access point by reading a header of a data packet sent by the second wireless device. Alternatively, if the first and second wireless devices are in a peer-to-peer configuration, the instruction may be sent directly from the first wireless device to the second wireless device. The wireless device may be a laptop computer, a PDA, or any other wireless device such as a cell phone, etc. Note also that the signal interference caused by the second wireless device may be due to the second wireless device responding to a reduced transmission power from the second access point, such that the reduced transmission power is caused by the second access point reducing a cell area serviced by the second access point such that in-band noise to nearby cells caused by the second access point is minimized.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
detecting, at a first wireless client device that communicates with a Wireless Local Area Network (WLAN) via a first access point, a signal interference that is caused by a second wireless client device that communicates with the WLAN via a second access point; and
minimizing the signal interference by sending an instruction to the second wireless access device to reduce a transmission power level of the second wireless device.

2. The method of claim 1, wherein the signal interference is an in-band radio frequency interference.

3. The method of claim 1, further comprising:
sending, to the second wireless device, multiple instructions to reduce the transmission power level of the second wireless device until the signal interference is reduced to a pre-determined acceptable level.

4. The method of claim 1, wherein the instruction is sent from the first access point to the second access point.

5. The method of claim 4, wherein the first access point identifies the second access point by reading a header of a data packet sent by the second wireless device.

6. The method of claim 1, wherein the first and second wireless devices are in a peer-to-peer configuration, and wherein the instruction is sent directly from the first wireless device to the second wireless device.

7. The method of claim 1, wherein the first wireless device is a laptop computer.

8. The method of claim 1, wherein the signal interference caused by the second wireless device is due to the second wireless device responding to a reduced transmission power from the second access point, and wherein the reduced transmission power is caused by the second access point reducing a cell area serviced by the second access point such that in-band noise to nearby cells caused by the second access point is minimized.

9. A system comprising:
a first access point to a Wireless Local Area Network (WLAN);
a first wireless device, wherein the first wireless device is wirelessly coupled to the first access point, and wherein the first wireless device comprises logic for detecting a signal interference that is caused by a second wireless client device that communicates with the WLAN via a second access point; and wherein the first access point comprises a transmitter for sending an instruction to the second wireless access device to reduce a transmission power level of the second wireless device to minimize the signal interference.

10. The system of claim 9, wherein the signal interference is an in-band radio frequency interference.

11. The system of claim 9, wherein the instruction is sent from the first access point to the second access point.

12. The system of claim 11, wherein the first access point identifies the second access point by reading a header of a data packet sent by the second wireless device.

13. The system of claim 9, wherein the first and second wireless devices are in a peer-to-peer configuration, and wherein the instruction is sent directly from the first wireless device to the second wireless device.

14. A computer-usable medium embodying computer program code, the computer program code comprising computer executable instructions configured for:
detecting, at a first wireless client device that communicates with a Wireless Local Area Network (WLAN) via a first access point, a signal interference that is caused by a second wireless client device that communicates with the WLAN via a second access point; and
minimizing the signal interference by sending an instruction to the second wireless access device to reduce a transmission power level of the second wireless device.

15. The computer-usable medium of claim 14, wherein the signal interference is an in-band radio frequency interference.

16. The computer-usable medium of claim 14, wherein the computer executable instructions are further configured for:
sending, to the second wireless device, multiple instructions to reduce the transmission power level of the second wireless device until the signal interference is reduced to a pre-determined acceptable level.

17. The computer-usable medium of claim 14, wherein the instruction is sent from the first access point to the second access point.

18. The computer-usable medium of claim 17, wherein the first access point identifies the second access point by reading a header of a data packet sent by the second wireless device.

19. The computer-usable medium of claim 14, wherein the first and second wireless devices are in a peer-to-peer configuration, and wherein the instruction is sent directly from the first wireless device to the second wireless device.

20. The computer-usable medium of claim 14, wherein the first wireless device is a laptop computer.
